(19) United States
(12) Patent Application Publication
(10) Pub. No.: US 2025/0185650 A1
(43) Pub. Date: Jun. 12, 2025

(54) NANOSTRUCTURED AGRICHEMICAL DELIVERY CARRIER

(71) Applicants: President and Fellows of Harvard College, Cambridge, MA (US); Nanyang Technological University, Singapore (SG)

(72) Inventors: Philip Demokritou, Brookline, MA (US); Kee Woei Ng, Singapore (SG); Jason C. White, Cambridge, MA (US); Tao Xu, Cambridge, MA (US)

(21) Appl. No.: 18/846,011

(22) PCT Filed: Mar. 10, 2023
(86) PCT No.: PCT/US2023/064141

§ 371 Date: Sep. 11, 2024

Related U.S. Application Data
(60) Provisional application No. 63/318,972, filed on Mar. 11, 2022.

(51) Int. Cl. A01N 25/28; A01N 25/10; A01P 3/00

(52) U.S. Cl. CPC A01N 25/28; A01N 25/10; A01P 3/00

(57) ABSTRACT

Various aspects of the instant disclosure relate to a nanostructured agrichemical delivery vehicle. The vehicle has a core-shell structure. The core includes a first polymeric material. The shell at least partially encases the core. The shell includes a second polymeric material. The core, the shell, or both include an agrichemical component distributed about the first polymeric material, the second polymeric material, or both. The release of the agrichemical component from the core, the shell or both is triggered by exposure to at least one of a predetermined enzyme, a predetermined pH, a predetermined biotic secretion, a predetermined temperature, a predetermined moisture content, a predetermined light source.

### CROSS-REFERENCE TO RELATED APPLICATION

This application claims the benefit of priority to U.S. Provisional Patent Application Ser. No. 63/318,972 entitled “NANOSTRUCTURED AGRICHEMICAL DELIVERY CARRIER,” filed Mar. 11, 2022, the disclosure of which is incorporated herein in its entirety by reference.

### BACKGROUND

Delivery of nutrients is helpful to facility growth of a plant. Delivery of nutrients can be somewhat inefficient. For example, a particular nutrient may not be delivers at the right time, place, and/or dose.

### SUMMARY OF THE INVENTION

The instant disclosure addresses, among other things, the inefficient delivery of nutrients and other substances to a plant.

Various aspects of the instant disclosure relate to a nanostructured agrichemical delivery vehicle. The vehicle has a core-shell structure. The core includes a first polymeric material. The shell at least partially encases the core. The shell includes a second polymeric material. The core, the shell, or both include an agrichemical component distributed about the first polymeric material, the second polymeric material, or both. The release of the agrichemical component from the core, the shell or both is triggered by exposure to at least one of a predetermined enzyme, a predetermined pH, a predetermined biotic secretion, a predetermined temperature, a predetermined moisture content, a predetermined light source.

Various aspects of the instant disclosure relate to a method of making nanostructured agrichemical delivery vehicle. The vehicle has a core-shell structure. The core includes a first polymeric material. The shell at least partially encases the core. The shell includes a second polymeric material. The core, the shell, or both include an agrichemical component distributed about the first polymeric material, the second polymeric material, or both. The release of the agrichemical component from the core, the shell or both is triggered by exposure to at least one of a predetermined enzyme, a predetermined pH, a predetermined biotic secretion, a predetermined temperature, a predetermined moisture content, a predetermined light source. The method includes disposing a liquid core precursor composition in a first chamber of a coaxial dispenser. The liquid core precursor composition includes the first polymeric material and optionally the agrichemical component. The method further includes disposing a liquid shell precursor in a second chamber of a coaxial dispenser, the liquid shell precursor composition includes the second polymeric material and optionally the agrichemical component. The method further includes applying a voltage to the coaxial dispenser. The method further includes applying a voltage to a substrate in flow communication with the coaxial dispenser. The method further includes flowing the liquid core precursor composition from the first chamber to the substrate. The method further includes flowing the shell precursor composition from the second chamber to the substrate.

### BRIEF DESCRIPTION OF THE FIGURES

The drawings illustrate generally, by way of example, but not by way of limitation, various embodiments of the present invention.

FIGS. 1A-1C are schematic figures showing (1A) the core-shell nanostructure and the concept of pH and enzyme stimuli responsive agrichemical release, (1B) the synthesis of pH and enzyme responsive core-shell nanostructure using electrospray, and (IC) the study design of plant growth study using pH and enzyme responsive core-shell nanostructures.

FIGS. 2A-2C are pictures and graphs showing morphology and size distribution of different types of core-shell nanostructures. FIG. 2A shows type I nanostructures, FIG. 2B shows type II nanostructures, and FIG. 2C shows type III nanostructures.

FIGS. 3A-3E are images showing a core-shell structure and element mapping of copper (3B), sulfur (3C), phosphorous (3D), and potassium (3E).

FIGS. 4A-4D show the release kinetics of copper under different pH and enzyme conditions. FIGS. 2A and 2B show type I and type II nanostructures under different pH conditions. FIGS. 2C and 2D show type I and type II nanostructures in the presence or absence of different enzymes.

FIGS. 5A-5D are graphs showing the photosynthesis profile of soybean and wheat. FIG. 5A shows the relative chlorophyll levels in soybean.

FIG. 5B shows the PS1 active centers in soybean. FIG. 5C shows levels of PhiNO in wheat. FIG. 5D shows LEF in wheat. Error bars correspond to the s.e.m. (n=5). Values shown by different letters are significantly different at p≤0.05 (one-way ANOVA with a Tukey post hoc test).

FIGS. 6A and 6B show element content in soybeans. FIG. 6A show zinc content in a soybean leaf. FIG. 6B shows sodium content in a soybean leaf. Values shown by different letters are significantly different at p≤0.05 (one-way ANOVA with a Tukey post hoc test).

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

The inefficient delivery of agrichemicals (fertilizers and pesticides) in agri-food systems (e.g., crops, livestock, forestry, aquaculture, and fisheries) is linked to serious negative planetary and public health impact. By some estimations, 60-90% of applied fertilizers and pesticides are lost due to evaporation, degradation and environmental run-off. Much of this inefficiency results from an inability to deliver the active ingredient to the right place (target), right time, and right dose. The Food and Agriculture Organization of the United Nations estimates that there will be a need to be a 70% to 100% increase in food production by 2050 to sustain the current population growth. Achieving this level of productivity becomes more challenging given the negative pressure from increased environmental stresses associated with a changing climate and a net loss of arable soil. Consequently, development of technologies for efficient, targeted and precise agrichemical delivery are needed.

Precision agriculture is lacking. For example, the release of agrichemicals mainly occurs by passive diffusion, capsule erosion, or osmotic pressure, resulting in poor control and high inefficiency of agrichemical delivery. The instant disclosure addresses this drawback by developing biotic and environmentally stimuli responsive nanostructured agrichemical delivery vehicle platforms for targeted and precise delivery in order to enhance crop development in both healthy and pathogen-infested conditions. Additionally, these nanostructured agrichemical delivery vehicles are able to use biodegradable, nontoxic materials and green synthesis processes that are in line with sustainable agriculture principles.

According to various examples, a nanostructured agrichemical delivery vehicle that can achieve the aforementioned benefits has a core-shell structure. The core-shell structure includes a core and also includes a shell that at least partially encases the core. For example, the shell can encase about 80 to about 100 percent of the total surface area of the core, about 90 to about 95 percent of the total surface area of the core, less than, equal to, or greater than about 80 percent of the total surface area of the core, 81, 82, 83, 84, 85, 86, 87, 88, 89, 90, 91, 92, 93, 94, 95, 96, 97, 98, 99, or about 100 percent of the total surface area of the core.

The core includes a first polymeric material and the shell includes a second polymeric material. The respective polymeric materials provide the structure of the core and shell. They also constitute the major component of the core and the shell. The core has an agrichemical component distributed about it. The shell can have an agrichemical component distributed about it, but in some examples the shell can be free of an agrichemical component. As described further herein, the release of the agrichemical component from the core, the shell or both is triggered by exposure to at least one of a predetermined enzyme, a predetermined pH, a predetermined biotic secretion, a predetermined temperature, a predetermined moisture content, a predetermined light source. As further described herein, the release can be controlled to substantially conform to a desired release profile.

The nanostructured agrichemical delivery vehicle is a “nanoscale” vehicle. For example, an average diameter of the nanostructured agrichemical delivery vehicle is in a range of from about 150 nm to about 300 nm, about 160 nm to about 170 nm, less than, equal to, or greater than about 150 nm, 160, 170, 180, 190, 200, 210, 220, 230, 240, 250, 260, 270, 280, 290, or about 300 nm. The thickness of the shell can be in a range of from about 10 nm to about 50 nm, from about 10 nm to about 30 nm, less than, equal to, or greater than about 10 nm, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 nm.

The shell and core can account for different amounts of the nanostructured agrichemical delivery vehicle. For example, the shell can range from about 45 wt % to about 62 wt % of the nanostructured agrichemical delivery vehicle, 47 wt % to about 60 wt % of the nanostructured agrichemical delivery vehicle, less than, equal to, or greater than about 45 wt % of the nanostructured agrichemical delivery vehicle, 46, 47, 48, 49, 50, 51, 52, 53, 54, 55, 56, 57, 58, 59, or about 60 wt % of the nanostructured agrichemical delivery vehicle. The core can range from about 38 wt % to about 55 wt % of the nanostructured agrichemical delivery vehicle, about 40 wt % to about 53 wt % of the nanostructured agrichemical delivery vehicle, less than, equal to, or greater than about 38 wt % of the nanostructured agrichemical delivery vehicle, 39, 40, 41, 42, 43, 44, 45, 46, 47, 48, 49, 50, 51, 52, 53, 54, 55, 56, 57, 58, 59, or about 60 of the nanostructured agrichemical delivery vehicle.

A specific surface area of the nanostructured agrichemical delivery vehicle can be in a range of from about 10 m²/g to about 30 m²/g, about 13 m²/g to about 20 m²/g, less than, equal to, or greater than about 10 m²/g, 11, 12, 13, 14, 15, 16, 17, 18, 19, 20, 21, 22, 23, 24, 25, 26, 27, 28, 29, or about 30 m²/g. The surface area can affect the release profile of the agrichemical component.

The first and second polymeric materials can include a single polymer or a mixture of polymers. Suitable polymers are those that are able to degrade or release an agrichemical component upon contact with any of the external triggering components described herein. Examples of suitable polymers of the first and second polymeric materials include polysaccharide-based biopolymers. As understood, a polysaccharide refers to a carbohydrate (e.g. starch, cellulose, or glycogen) whose molecules include of a number of sugar molecules bonded together. As further understood, biopolymers are natural polymers produced by the cells of living organisms. The polysaccharide can account for 50 wt % to 100 wt % of the polysaccharide-based biopolymer, 70 wt % to 100 wt % of the polysaccharide-based biopolymer, less than, equal to, or greater than about 50 wt %, 55, 60, 65, 70, 75, 80, 85, 90, 95, or about 100 wt % of the polysaccharide-based biopolymer. Portions of the polysaccharide-based biopolymer, that are not a polysaccharide can include any suitable moiety or repeating unit that is not a saccharide.

The first polymeric material and the second polymeric material can be the same (e.g., include the same polymer or mixture of polymers) or the first polymeric material and the second polymeric material can be different. In some examples, the first polymeric material and second polymeric material can include the same mixture of polymers, but the amounts of individual polymers can differ in the respective mixtures.

Examples of polysaccharide-based polymers of the first polymeric material, the second polymeric material or both can include cellulose acetate, chitosan, zein, corn starch, polycaprolactone, or a mixture thereof. As understood, cellulose acetate refers to any acetate ester of cellulose. As an example the cellulose can include 39.8 wt % acetyl. As understood, chitosan refers to a linear polysaccharide including randomly distributed β-(1→4)-linked D-glucosamine (deacetylated unit) and N-acetyl-D-glucosamine (acetylated unit). As understood, zein is a class of prolamine protein found in maize (corn), it is usually manufactured as a powder from corn gluten meal. As understood, corn starch is obtained from the endosperm of a corn kernel and is a common food ingredient, often used to thicken sauces or soups, and to make corn syrup and other sugars and can be food-grade or pharma grade. As understood, polycaprolactone is a biodegradable polyester with a low melting point of around 60° C. and a glass transition temperature of about −60 C. The polycaprolactone can have a weight-average molecular weight of about 60,000 to about 100,000 or 75,000 to 85,000.

In an example, the first polymeric material includes a mixture of cellulose acetate, chitosan, zein, corn starch, and polycaprolactone. This mixture can allow for the tuning of the release of an agrichemical component. The tuning can be achieved by controlling the amount of each polymer present in the first polymeric material. As an example, cellulose acetate can range from about 30 wt % to about 50 wt % of the first polymeric material; chitosan can range from about 20 wt % to about 40 wt % of the first polymeric material; zein can range from about 5 wt to about 20 wt % of the first polymeric material; corn starch can range from about 5 wt to about 20 wt % of the first polymeric material; and polycaprolactone can range from about 5 wt to about 20 wt % of the first polymeric material. In further examples cellulose acetate can range from about 35 wt % to about 45 wt % of the first polymeric material; chitosan can range from about 25 wt % to about 35 wt % of the first polymeric material; zein can range from about 10 wt to about 15 wt % of the first polymeric material; corn starch can range from about 10 wt % to about 15 wt % of the first polymeric material; and polycaprolactone can range from about 10 wt to about 15 wt % of the first polymeric material.

The content of the second polymeric material can differ with respect to the first polymeric material. Differing the respective contents of the first polymeric material and the second polymeric material can help to provide differing release rates of the agrichemical component. As an example the second polymeric material includes cellulose acetate, chitosan, polycaprolactone, or a mixture thereof. In another example, the second polymeric material includes cellulose acetate, chitosan, and polycaprolactone. Similar to the first polymeric material, tuning mixture can allow for the tuning of the release of an agrichemical component. The tuning can be achieved by controlling the amount of each polymer present in the second polymeric material. As an example of tuning, the composition of the respective polymeric compositions can turn the make the core or shell more of less hydrophilic. If the core or shell is more hydrophilic, then it may degrade faster upon exposure to moisture. As an example of a formulation, cellulose acetate can range from about 20 wt % to about 30 wt % of the second polymeric material; chitosan can range from about 20 wt % to about 30 wt % of the second polymeric material; and polycaprolactone can range from about 40 wt % to about 60 wt % of the second polymeric material. In further examples, cellulose acetate can range from about 23 wt % to about 28 wt % of the second polymeric material; chitosan can range from about 23 wt % to about 28 wt % of the second polymeric material; and polycaprolactone can range from about 44 wt % to about 56 wt % of the second polymeric material.

The agrichemical component present in the core, optionally the shell, or both the core and the shell can include a micronutrient, a macronutrient, a pesticide, a fungicide, or a mixture thereof. A micronutrient is understood to refer to a chemical element or substance required in trace amounts for the normal growth and development of living organisms. Examples of micronutrients that can be present include copper, boron, zinc, manganese, iron, molybdenum, chlorine, or a mixture thereof. The micronutrients mentioned here can be in elemental form or in ionic form (e.g., a cation of a salt). For example, the copper can be present as CuSO₄. Counterions to the cations can include sulfates, sulfites, nitrates, nitrites, ammonia, hydroxides, or the like.

Macronutrients are understood to refer to a chemical element or substance required in larger amounts than micronutrients for the normal growth and development of living organisms. Examples of macronutrients can include nitrogen, phosphorus, potassium, or a mixture thereof. Nitrogen, phosphorous, and potassium are sometimes referred to as “primary macronutrients”. In some examples the agrichemical component can include “secondary macronutrients”, which are also essential but are consumed in smaller quantities than primary macronutrients. Examples of secondary macronutrients include calcium, magnesium, and sulfur. Like the micronutrients, the macronutrients can be present in elemental form or as part of an ionic pair.

The agrichemical component can also include other components such as pesticides or fungicides. Examples of pesticides include organophosphates, pyrethroids, carbamates, and mixtures thereof. Examples of fungicides include captan, an organo mercurial, thiram, zineb, maneb, chlorneb, copper hydroxide, copper oxychloride, pentachloronitrobenzene, fludioxonil, carboxin, or a mixture thereto.

The agrichemical component can be distributed about the nanostructured agrichemical delivery vehicle in a variety of ways. For example, the agrichemical component can be present in both the shell and the core. In examples where the agrichemical component is present in both the shell and the core, an equal portion (e.g., of the total wt % of the agrichemical component in the nanostructured agrichemical delivery vehicle) of the agrichemical component can be in the shell and core. Alternatively, a major portion (e.g., greater than 50 wt % of the total amount of agrichemical component) can be located in either of the shell or the core. Within the shell or the core, the agrichemical component can be homogenously distributed or heterogeneously distributed. The agrichemical component can be internally disposed within the core, shell or both. If the agrichemical component is present in the shell, at least a portion of the agrichemical component can be coated or otherwise applied to an external surface of the shell. In some examples, the agrichemical component is only located in the core and the shell is substantially free of (e.g., includes less than 1 wt %) agrichemical component or free of (e.g., includes 0 wt %) agrichemical component.

The nanostructured agrichemical delivery vehicle functions by allowing the shell and core to biodegraded upon a triggering event. In operation, one or more of the nanostructured agrichemical delivery vehicles are located proximate to a plant. The nanostructured agrichemical delivery vehicles can be buried beneath the ground or soil in which the plant is located. Alternatively, the nanostructured agrichemical delivery vehicles can be disposed on the ground or soil in which the plant is located. In some further examples, a portion of the nanostructured agrichemical delivery vehicles can be disposed on the ground or soil in which the plant is located and another portion of the nanostructured agrichemical delivery vehicles can be buried beneath the ground or soil in which the plant is located. The plant itself can be germinated or not or at any other stage of growth at the time the nanostructured agrichemical delivery vehicle is located proximate thereto.

Upon a triggering event, the respective polymeric materials of the shell, core, or both will begin to degrade. This leads to the controlled release of the agrichemical component from the shell, core, or both. Examples of triggering events include exposing the nanostructured agrichemical delivery vehicle to a predetermined enzyme, a predetermined pH, exposing the nanostructured agrichemical delivery vehicle to a predetermined biotic secretion, a predetermined temperature, a predetermined moisture content, a predetermined light source, or a combination thereof. Examples of a biotic secretion include an exudate secreted from a plant pathogen, and insect, a weed species, or a combination thereof. Examples of exudates can include an enzyme, mineral, hormone, growth factor, or the like. Exposure to a predetermined enzyme can be accomplished when the polymeric material of the shell, core, or both includes a substrate of the predetermined enzyme. Exposure to the predetermined temperature can be accomplished if the polymeric material of the shell, core, or both are thermosensitive. Exposure to the predetermined moisture content can be accomplished if the polymeric material of the shell, core, or both are moisture sensitive. Exposure to the predetermined light source can be accomplished if the polymeric material of the shell, core, or both are photosensitive. The predetermined pH can be within a range where a polymeric component of the core, the shell, or both can be degraded. For example if the core, shell, or both include chitosan, degradation may occur at a pH of 6 or lower.

Degradation of the shell, core, or both, upon a triggering event, affects the release profile of the agrichemical component. For example, the degradation can be at a constant rate or a variable rate. As a result, the release of the agrichemical component can be a sustained release, an extended release, a staggered release, or a delayed release.

The nanostructured agrichemical delivery vehicle can be produced according to many different methods. For example, a method of making a nanostructured agrichemical delivery vehicle can include a coaxial electrospray method, which includes disposing a liquid core precursor composition in a first chamber of a coaxial dispenser. The liquid core precursor composition can include the first polymeric material and optionally the agrichemical component. Additionally, a liquid shell precursor can be located in a second chamber of a coaxial dispenser. The liquid shell precursor composition includes the second polymeric material and optionally the agrichemical component. Once the respective chambers are loaded. A voltage is applied to the coaxial dispenser.

A substrate is located beneath an outlet of the coaxial dispenser. A voltage is applied to the substrate. Once the voltage is applied to both the coaxial dispenser and the substrate, the liquid core precursor and shell precursor are flowed from their respective chambers to the substrate to form the nanostructured agrichemical delivery vehicle.

The coaxial dispenser and substrate are each formed from an electrically conductive material. Examples of electrically conductive materials include stainless steel, copper, or the like. To facilitate the flow from the coaxial dispenser to the substrate, the voltage applied to each component is different. For example, the voltage applied to the coaxial dispenser is a positive direct current voltage in a range of from about 15 kV to about 40 kV, about 20 kV to about 35 kV, less than, equal to, or greater than about 15 kV, 16, 17, 18, 19, 20, 21, 22, 23, 24, 25, 26, 27, 28, 29, 30, 31, 32, 33, 34, 35, 36, 37, 38, 39, or 40 kV. Additionally, the voltage applied to the substrate is a negative direct current voltage in a range of from about 1 kV to about 15 kV, about 2 kV to about 10 kV, less than, equal to, or greater than about 1 kV, 2, 3, 4, 5, 6, 7, 8, 9, 10, 11, 12, 13, 14, or 15 kV. The voltages applied can help to control the flow rate of the core precursor and the shell precursor. For example, a flow rate of the core precursor and the shell precursor can be substantially equivalent. Alternatively, a flow rate of the core precursor and the shell precursor are different. Differing the flow rates can help to adjust the size of the nanostructured agrichemical delivery vehicle or the respective thicknesses of the core and shell. As an example, a flow rate of the core precursor and the shell precursor independently range from about 0.01 ml/h to about 0.60 ml/h, about 0.05 ml/h to about 0.40 ml/h, less than, equal to, or greater than about 0.01 ml/h, 0.02, 0.03, 0.04, 0.05, 0.06, 0.07, 0.08, 0.09, 0.10, 0.15, 0.20, 0.25, 0.30, 0.35, 0.40, 0.45, 0.50, 0.55, 0.60 ml/h.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### EXAMPLES

Various embodiments of the present invention can be better understood by reference to the following Examples which are offered by way of illustration. The present invention is not limited to the Examples given herein.

### Materials

Cellulose acetate (180955, average Mn=30,000 by GPC), chitosan (448869, low molecular weight), Zein (Z3625), starch from corn (S4126), polycaprolactone (440744, average Mₙ=80000), copper (II) sulfate (C1297), formic acid (695076, ACS reagent), acetic acid (695092, ACS reagent), protease from Streptomyces griseus (P5147, Type XIV, ≥3.5 units/mg), α-amylase from Aspergillus oryzae (10065, ˜30 units/mg), buffer solution (1094361000, citric acid/sodium hydroxide, pH=5), DI water (8483331000, pH=7) were purchased from Sigma-Aldrich. Peters Professional 20-20-20 General Purpose Fertilizer (SKU #E99290) was purchased from Everris Na Inc. All chemicals were used without further purification.

### Selection of Polymers, Agrichemicals, and Solvents

Selection of polymers. To achieve pH and enzyme responsiveness, different types of biopolymers were blended. Chitosan was selected to achieve pH responsive functionality, due to its pH sensitivity. The soluble-insoluble transition of chitosan occurs at its pKa value of pH 6.0-6.5. Generally, when the pH is higher than 6.0, the amine group becomes deprotonated, making chitosan insoluble; when the pH is lower than 6.0, the amine is protonated, making it a water-soluble cationic polyelectrolyte. Starch and zein can be degraded by amylase and proteinase secreted by phytopathogenic fungi in soil and thus, were selected to achieve enzyme responsive functionality. Additional polymers e.g., cellulose acetate (CA) and polycaprolactone (PCL) were incorporated to tune the nanostructure surface properties and morphology. Specifically, CA is a common derivative of cellulose and was selected as an additive polymer due to its hydrophobicity, which could prevent rapid agrichemical passive diffusion in the early release stage. PCL is a biodegradable synthetic biomaterial and was selected to improve the electrospray processing stability and the morphology of the resulting nanostructures. In addition, PCL exhibited a rapid degradation rate compared to other polyesters such as polyhydroxybutyrate, polylactic acid and poly(1,4 butylene) succinate.

Selection of agrichemicals. An agrichemical mixture containing select micronutrients and macronutrients was used. Micronutrients are important to crop growth and nutrition but also have a role in pathogen (fungal, bacterial) defense. Cu(CuSO₄ as the model chemical) was selected as a model micronutrient because of its importance to plant health and growth, as well as an activator plant disease immunity. Copper is critical to a number of important metabolic pathways, including those involving secondary metabolites and abiotic/biotic stress response, and it is used to effectively promote plant resistance against pathogens. Cu also has direct antimicrobial activity against a range of microorganisms. Macronutrients used in the agrichemical mixture include nitrogen (N), phosphorus (P) and potassium (K), which are fertilizer components (collectively referred to as “NPK”) and are required by plants at high levels. Commercial fertilizer (Peters Professional 20-20-20 general purpose) was selected as the NPK source.

The agrichemical mixture (e.g., CuSO₄ and NPK fertilizer) was incorporated into both the core and shell polymeric material by direct solution integration. The optimized agrichemical concentration and composition of individual micro/macronutrients were determined according to their solubility in a “green” solvent system (acetic acid/formic acid/H₂O mixture) but we note that this is likely crop and application specific.

Selection of solvents. Due to the complexity of various polymers and agrichemicals, wise selection of solvents is needed to form a uniform precursor solution for subsequent electrospray processing. In order to fit within the scope of sustainable agriculture, toxic organic solvents typically used in electrospray of polymers were avoided. An acetic acid/H₂O mixture, which is “Generally Recognized as Safe” (GRAS) by the US Food and Drug Administration (FDA), was selected as the starting solvent to dissolve the biopolymers and agrichemicals. The solubility of polymers and agrichemicals in this “green” solvent system was acceptable (data not shown), with the exceptions being starch and CuSO₄. To further increase the solubility of these analytes, formic acid, which is also a “GRAS” solvent, was added into AA/H₂O to form the final solvent system, e.g., FA/AA/H₂O. After optimization, the FA/AA/H₂O ratio was fixed at 40/40/20 (v/v/v/) to achieve the greatest solubility of polymers and agrichemicals. It is worth noting that FA/AA/H₂O can dissolve both ionic micronutrients and NPK fertilizer, and that traditional organic solvents typically lack this ability.

### Preparation of Precursor Solution for Coaxial Electrospray

Three types of core-shell nanostructures with different shell polymer compositions and agrichemical concentrations in core and shell were prepared. Type I nanostructure (fast release) was designed to have a more hydrophilic shell with equal agrichemical amounts in the shell (50%) and core (50%); the Type II nanostructure (intermediate release) was designed to have a more hydrophobic shell with less agrichemical in the shell (25%) and more in the core (75%); and the Type III nanostructure (slow release) was designed to have the most hydrophobic shell with agrichemical only in the core (100%). The detailed formulations used to synthesize the different types of core-shell nanostructures are shown in Table 1.

TABLE 1
Core and shell composition to synthesize different
types of responsive core-shell nanostructure.

| | Shell Formulation | | | | | | | | | |
|---|---|---|---|---|---|---|---|---|---|---|
| | Solvent (ml) | | | Biopolymer (3%, w/v) (mg) | | | | | Agrichemical (mg) | |
| | AA | FA | H2O | CA | CS | Zein | Starch | PCL | CuSO4 | NPK |
| Type I | 4 | 4 | 2 | 105 | 90 | 45 | 45 | 15 | 5 | 60 |
| Type II | 4 | 4 | 2 | 120 | 90 | 30 | 30 | 30 | 2.5 | 30 |
| Type III | 4 | 4 | 2 | 120 | 90 | 30 | 30 | 30 | 0 | 0 |

| | Core Formulation | | | | | | | |
|---|---|---|---|---|---|---|---|---|
| | Solvent (ml) | | | Biopolymer (2%, w/v) (mg) | | | Agrichemical (mg) | |
| | AA | FA | H2O | CA | CS | PCL | CuSO4 | NPK |
| Type I | 4 | 4 | 2 | 50 | 50 | 100 | 5 | 60 |
| Type II | 4 | 4 | 2 | 50 | 50 | 100 | 7.5 | 90 |
| Type III | 4 | 4 | 2 | 50 | 50 | 100 | 10 | 120 |

To prepare the shell precursor solution, starch and PCL were first dispersed in formic acid and stirred for 10 hours at ambient temperature, and then acetic acid and water were added into the solution, followed by stirring for another 2 hours. Chitosan and CuSO₄ were then dispersed in the resulting solution, with stirring for an additional 10 hours. Finally, cellulose acetate, zein, and the macronutrient fertilizer components were added to the polymer solution, which was then stirred for 2 hours to obtain the shell precursor solution.

To prepare the core precursor solution, PCL was dispersed in formic and acetic acid and the mixture was stirred for 4 hours at ambient temperature. Subsequently, water and CuSO₄ were added to the solution, followed by stirring for another 8 hours. Finally, chitosan, cellulose acetate, and the macronutrient fertilizer components were added in the polymer solution, which was then stirred for 4 hours to obtain the core precursor solution.

### Synthesis of Responsive Core-Shell Nanostructures Using Coaxial Electrospray

The shell and core precursor solution was filled into 10 mL BD Luer-Lok tip plastic syringes. The plastic syringes were connected with stainless-steel (AISI 304) coaxial needle (900 blunt end) with core needle diameter of 0.9/0.6 mm (outer/inner) and shell needle diameter of 1.7/1.4 mm (outer/inner). The electrospray device (Professional Lab Device, DOXA Microfluidics, Milaga, Spain) included a high voltage power supply, a plate collector, and two syringe pumps. During electrospraying, a positive direct current voltage of 30 kV was applied to the stainless-steel coaxial needle and a negative voltage of 5 kV was applied to the plate collector; and the distance between the needle tip and the surface of collector (i.e., the plate collector covered with aluminum foil) was set at 15 cm. The core and shell solution flow rate were individually controlled by separate syringe pumps. The flow rate used to synthesize the nanostructures was 0.2 ml/h and 0.2 ml/h for both core and shell. It is worth noting that in order to study the effect of core and shell flow rate on nanostructure morphology, three other flow rates were investigated, e.g., (1) core: 0.1 ml/h, shell: 0.1 ml/h; (2) core: 0.1 ml/h, shell: 0.2 ml/h; and (3) core: 0.2 ml/h, shell: 0.4 ml/h were applied to synthesize nanostructures. The electrospray nanostructures were collected as a randomly overlaid coating on aluminum foil; these structures were readily detached from the foil using a brush and were collected for further use.

### Physicochemical Characterization of Responsive Core/Shell Nanostructures

The morphology of the electrospray nanostructures was characterized by Zeiss Ultra Plus field-emission scanning electron microscope (SEM). The diameter of nanofibers was measured using the ImageJ software (n=50). The core-shell structure was characterized by ultra-high resolution transmission electron microscopy (TEM). The element distribution in the nanostructure was characterized by energy dispersive X-ray spectroscopy (EDS). The water contact angle was measured by an in-house system (MET-6, Center for Nanoscale Systems, Harvard University) that captures a digital image of the droplet and then an ImageJ plug-in was used to determine the contact angle. The BET (Brunauer-Emmett-Teller) specific surface area, total pore volume, and average pore size of were characterized by NOVAtouch (Quantachrome Instruments). Fourier transform infrared (FT-IR) spectra were acquired by Nicolet iS50 FTIR Spectrometer (Thermo).

### Agrichemical Release Kinetics Study

For pH responsive release, the nanostructures were dispersed in pH 5 buffer solution and pH 7 water. For enzyme responsive release, the nanostructures were dispersed in a solution with a total enzyme concentration of 1 U/ml. Specifically, protease (14.3 mg) and α-amylase (1.7 mg) were added into 50 ml DI water (pH=7) and mechanically stirred for 1 hour to form a uniform enzyme solution. The control group was the same solution without enzymes.

The same nanostructure concentration was used for the release kinetics study and the greenhouse study; 2.64 mg/ml, which equates to 132 mg nanostructures in 50 ml H₂O for one plant (additional details below). Specifically, 13.2 mg nanostructures were dispersed in 5 ml of the aforementioned solution; triplicate samples were established. The obtained suspension was immersed in a water bath sonicator for 5 mins to disperse the nanostructures. At predetermined intervals, the nanostructure containing solution was first centrifuged (at 3000 rpm for 20 mins) and then 200 μl supernatant was withdrawn and collected for Cu²⁺ release kinetics determination. The Cu content of the sample was determined by inductively coupled plasma optical emission spectroscopy (JCP-OES; iCAP 6500; Thermo Fisher Scientific, Waltham, MA). Subsequently, another 200 μl of the corresponding solution was added back to the original solution to maintain a volume of 5 ml. The Cu²⁺ release percentage at each time point was calculated as:

$$Cu Release Percent = \frac{WCu}{W 0 ( Cu )} \times 100 \% \qquad ( 1 )$$

where W_{0(Cu)} is the initial weight of Cu²⁺ in the nanostructure (measured by Cu²⁺ loading percentage in nanostructure×W₀), W_{Cu} is the weight of Cu²⁺ released in the solution at each time point.

### Greenhouse Experiments

For the greenhouse experiments, soybean (Glycine max L.) and wheat (Triticum aestivum L.) seeds were germinated in 36 cell (5.66×4.93×5.66 cm) plastic liners (1 seed per cell) filled with soilless potting mix (ProMix BX. Premier Hort Tech, Quakertown, PA, USA). The Type II nanostructure was selected for the greenhouse study due to its high pH sensitivity under healthy soil conditions. After two and three weeks, uniformly sized seedlings of soybean and wheat, respectively, with 3-4 leaves were transferred to fresh pots containing 350 mL of Promix amended with Type II nanostructures at 132 mg per pot, equivalent to 25 mg NPK and 0.85 mg Cu in total. Treatments of conventional NPK fertilizer with/without additional Cu at an equivalent amount (25 mg) or at levels that were 4 times higher but were consistent with conventional application recommendations (100 mg) were included as controls. To prepare this growth media, each pot containing 350 mL Promix was initially amended with 50 mL of DI, and left to stabilize for 24 h. The amendments were weighed based on the amount needed in Promix, and were suspended in 30 mL DI. After sonication for 30 sec with a probe sonicator at 500 W (FB505, Fisher Scientific, Pittsburgh, PA), the nano-suspensions were added into Promix and mixed manually to achieve homogeneity. Thirty mL of DI was applied to the controls. The plants were cultivated in a completely randomized block design under standard lighting and temperature conditions (25 and 22° C. for day and night, relative humidity of 60-70%, and a light intensity of 16,500×). There were six replicates in each treatment. Soybean and wheat were harvested at 4 and 8 weeks after sowing, respectively; the relative chlorophyll content, PS1 center activity, quantum yield of other unregulated (nonphotochemical) losses (PhiNO), and linear electron flow (LEF) of the leaves were measured using a portable PhotosynQ (PHOTOSYNQ INC., USA) at 5 and 13 days after the transplanting.

### Element Measurement

Leaf, root, and grain tissue samples of soybean and wheat were collected at harvest, and were washed and then rinsed with 0.01% nitric acid as well as DI to remove any adhering particles. The samples were dried at 60° C. for 2 days, and were ground to fine powders. Approximately 0.2 mg of sample were weight, and digested with 5 mL plasma pure HNO₃ using a hot block at 115° C. for 45 min. The digests were diluted with DI, and analyzed by inductively coupled plasma-optical emission spectrometry (ICP-OES) (iCAP 6500, Thermo Fisher Scientific, Waltham, MA). For quality control, a blank control (no plant tissues) and standard reference material (NIST-SRF 1570a and 1547, Metuchen, NJ) were prepared following the same procedure. Yttrium, the internal standard, were injected for each run. A continuing calibration verification sample was analyzed every 15 samples.

### Statistical Analysis

A Student t test was used to calculate the significant difference between each treatment and the controls at p<0.05 or p<0.01. One-way ANOVA followed by a Tukey-Kramer multiple comparison tests was also used to determine significant differences at p<0.05. Data are expressed as the mean±standard error (SE).

### Results and Discussion

### “Green” Synthesis of Responsive Core-Shell Nanostructures for Agrichemical Delivery

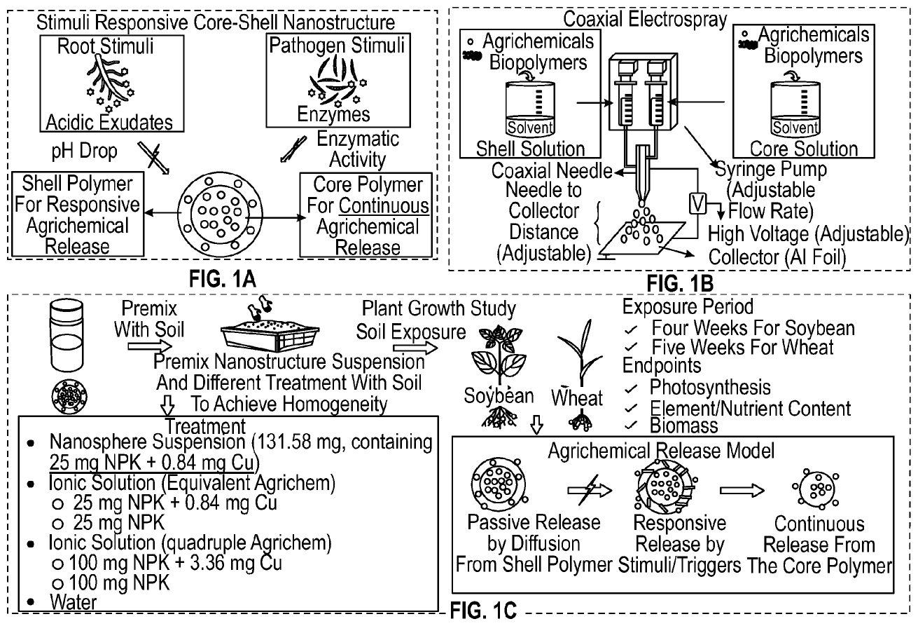

Design strategy for biotic and abiotic stimuli responsive nanostructures with tunable surface hydrophobicity. FIG. 1A summarizes the design strategy of biodegradable, pH and enzyme responsive core-shell nanostructures. The shell polymer was designed to be responsive to pH changes and enzyme exposure, while the core polymer was designed to continuously release the agrichemicals over the longer term. Specifically, chitosan was selected to achieve pH responsive functionality, due to its pH sensitivity. Starch and zein that can be degraded by amylase and proteinase were utilized to achieve enzyme responsive functionality. Hydrophobic polymers (e.g., cellulose acetate/PCL) were used as core polymer for continuous and controlled release. Additionally, different biopolymer compositions and agrichemical concentrations in shell and core were selected to achieve tunable surface hydrophobicity in order to control and the agrichemical release kinetics.

Fine-tuning the polymer/agrichemical composition and surface hydrophobicity of the nanostructures. FIG. 1B shows the green synthesis of nanostructures using the coaxial electrospray approach. To achieve spherical core-shell nanostructures and minimize the sizes in order to reach the highest specific surface area, an optimization was performed by tuning the electrospray conditions (e.g., core/shell polymer flow rates and voltage) and precursor solutions (e.g., the shell and core polymer compositions and agrichemical concentrations).

Three types of core-shell nanostructures (termed Type I, II, III) with different biopolymer/agrichemical compositions in both the shell and core were synthesized to demonstrate the ability to have tunable surface hydrophobicity and agrichemical release kinetic profiles. Specifically, the Type I nanostructure was designed to have a hydrophilic surface; the Type II nanostructure was designed to have a hydrophobic surface; and the Type III nanostructure was designed to have the most hydrophobic surface. Importantly, the total agrichemical in the three nanostructures was identical; however, the proportion of agrichemical in the core and shell was different.

### Morphological Characterization of Responsive Core-Shell Nanostructures

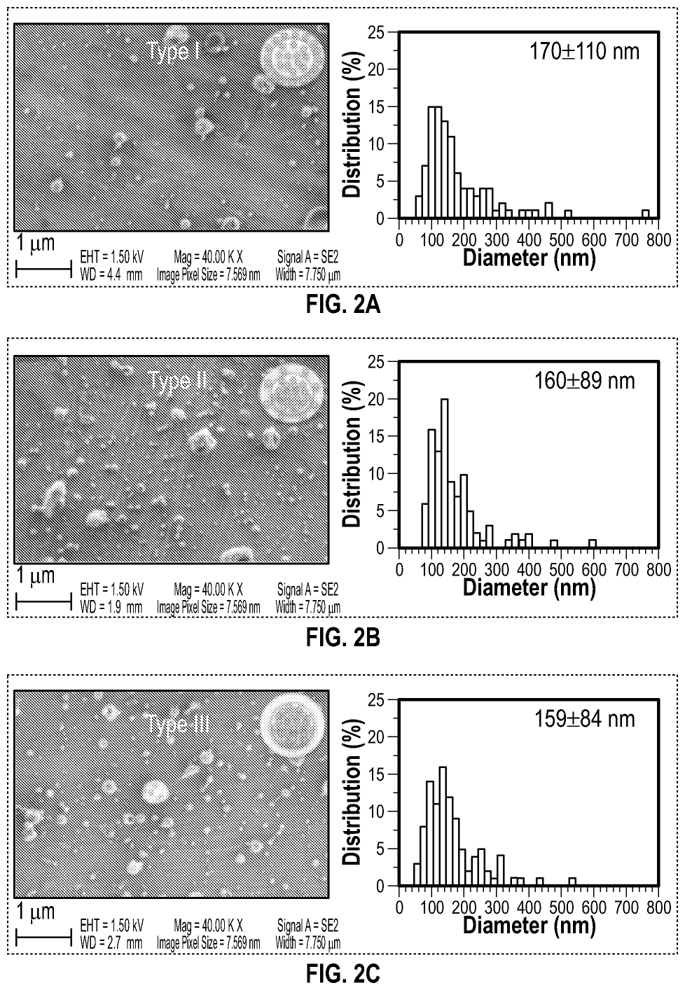

Morphology of core-shell nanostructures. FIG. 2 shows the morphology and size distribution of the three different core-shell nanostructures. After optimization of electrospray parameters (voltage, flow rate, needle to collector distance etc.), all three types of nanostructures showed regular spherical shape. The average diameter for Type I, II, and III nanostructure was 170±110 nm, 160±89 nm and 159±84 nm, respectively. All the electrosprayed nanostructures were easily removed from the substrate (aluminum foil). It is worth noting that the size of electrospray particles was typically larger than 200 nm.

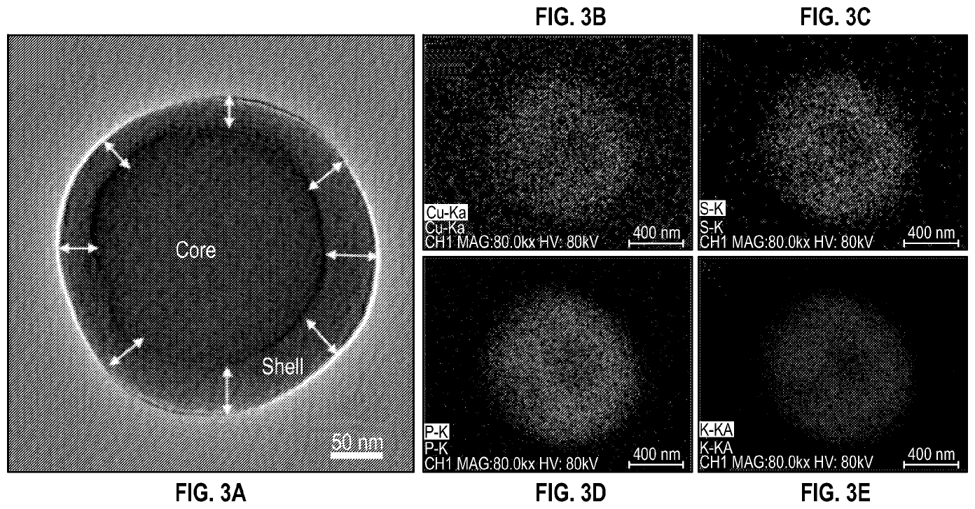

Confirmation of core shell structure. To verify and characterize the core shell structure, a high-resolution TEM was used. As shown in FIG. 3A, the nanostructure (Type I) shows a shell thickness of about 30 nm and a clear boundary between core and shell, confirming the intended design. In addition, TEM-EDS was performed to verify the distribution of agrichemicals in the core-shell nanostructures. As shown in FIG. 3B-E, the element mapping of Cu, S, P, and K shows the nanostructure morphology and highlight the uniform distribution of agrichemicals (e.g., CuSO₄ and NPK fertilizer) in the nanostructure.

Effect of core and shell electrospray flow rate on nanostructure morphology. The Type I material was used as a model to study the effect of core and shell flow rates on nanostructure morphology. The resulting nanostructures all show regular spherical morphology, and with the increasing core and shell flow rate, the average diameter could be increased (e.g., 129±80 nm, 169±112 nm and 249±181 nm).

In addition, other aspects of the core-shell nanostructures can also be affected by the flow rate. Shell thickness was quite small when the shell flow rate was 0.1 ml/h. As the shell flow rate increased to 0.2 ml/h, the shell thickness also increased. Further increasing the flow rate did not affect the core shell structure, but the total size of the particle was increased. These findings demonstrate the highly tunable nature of the nanostructures with regard to both size and shell thickness; these properties can readily be adjusted to further affect and control agrichemical release kinetics.

### Physicochemical Characterization of the Core-Shell Nanostructures

Specific surface area of core-shell nanostructures. The specific surface area of three nanostructures were analyzed by N₂ adsorption-desorption isotherm measurements. The N₂ adsorption-desorption plots can be classified as Type II under the Brunauer classification. The adsorption behavior included adsorption in the low pressure region, gradually increased adsorption in middle P/P0 region, and further adsorption increases in high pressure region. Table 2 summarizes the microstructure of different types of core-shell materials.

TABLE 2
Microstructure of different types of
responsive core-shell nanostructure.

| | BET multipoint | | Total Pore |
|---|---|---|---|
| | Specific Surface Area | Average Pore Size | Volume |
| | (m²/g) | (diameter) (nm) | (cc/g) |
| Type I | 14.23 | 6.09 | 0.022 |
| Type II | 15.52 | 6.34 | 0.025 |
| Type III | 18.29 | 7.18 | 0.033 |

Type I, II and, III nanostructures showed similar BET specific surface area (14.23, 15.52, and 18.29 m²/g, respectively) and pore structure. Compared to a conventional bulk fertilizer, nanostructures with high specific surface area will enable efficient loading of reduced agrichemical quantities, and can be used to enhance agrichemical efficacy while minimize the potential negative environmental health impacts associated with agrichemical impacts on non-target species.

Chemical structure of core-shell nanostructures. The characteristic peaks of CA, CS, Zein, Starch, and PCL are evident in the FTIR spectra of three nanostructures. Specifically, the characteristic peaks of CA were located at about 3450 (—OH stretching), 1726 (—C═O stretching), 1367 cm⁻¹ (C—CH₃ stretching), and 1234 (C—O—C stretching) attributed to vibrations of the acetate groups. The characteristic peaks of PCL were observed at 2940 and 2870 cm⁻¹ (—CH2-), 1726 cm⁻¹ (—C═O), 1246 cm⁻¹ (C—O—C), and these peaks overlap with the characteristic peaks of CA. The spectra showed the characteristic peaks of chitosan, including a strong and broad peak at 3345 cm⁻¹ due to an —OH stretching vibration with overlapping peaks of —NH stretching, and peaks at 2940 and 2870 cm⁻¹ relating to the CH stretching modes. In addition, the spectra exhibited characteristic peaks of zein (protein) at 3345 cm⁻¹ (N—H stretching vibrations), 2940 cm⁻¹ and 2870 cm⁻¹ (C—H stretching vibrations of aliphatic groups), as well as t644 cm⁻¹ (amide I) and 1527 cm⁻¹ (amide II). The amide I peak was due to the C═O stretch vibrations, while the amide II peak was derived from N—H bending and C—N stretching vibrations. The spectra also showed typical peaks for the starch backbone. For example, peaks observed at 1156 and 1050 cm⁻¹ indicate the presence of —C—O— of glucose (C—O deformation), while the peaks observed at 831 cm⁻¹ (C—O—C stretching) and 735 cm⁻¹ (C—O—C bending) correspond to the skeletal stretching and bending vibrations of starch.

The characteristic peaks of CA, PCL, CS, zein, and starch in the core shell nanostructures confirm the successful formation of composite nanostructure by physical blending/mixing. The characteristic peaks observed from the spectra for the nanostructures (polymer blends) have a slight shift compared to the individual CA/CS/Zein/Starch/PCL analytes, which is likely due to the interactions among each component (e.g., hydrogen bond). Furthermore, the Type I nanostructure showed pronounced characteristic peaks compared to Type II and Type III nanostructures, possibly due to the shell polymer composition differences between materials. Note that the core polymer composition of the Type I, II, and III nanostructure was identical (e.g., CA/CS/PCL=25/25/50, 2%, w/v). The shell polymer composition of the Type I nanostructure was CA/CS/Zein/Starch/PCL=35/30/15/15/5 (3%, w/v), whereas shell polymer composition of Type II and Type III nanostructures were CA/CS/Zein/Starch/PCL=40/30/10/10/10 (3%, w/v). Such composition differences in shell enable the tunable surface hydrophobicity and agrichemical release kinetics.

### Release Kinetics of Core/Shell Nanostructures Under Different Conditions

The Cu²⁺ release kinetics from core-shell nanostructures as a function of time under different pH conditions, and in the presence or absence of specific enzymes was investigated.

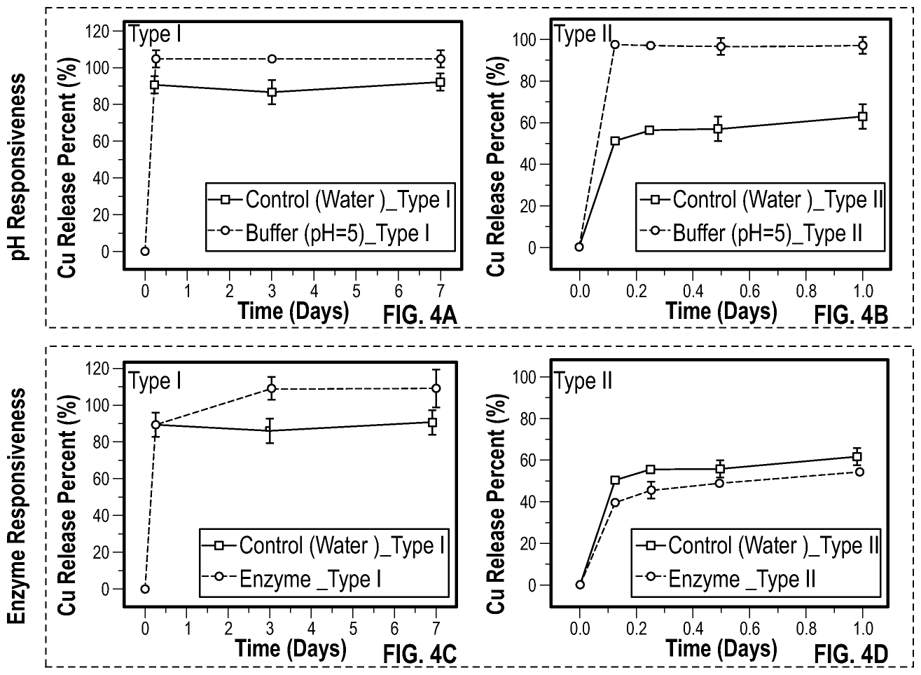

Release kinetics under different pH conditions. Cumulative Cu release from core-shell nanostructures at 25° C. in buffer solutions (pH 5.0) and water (pH 7.0) is shown in FIGS. 4A & B. The Type I nanostructures exhibited an obvious burst of Cu²⁺ release at pH 7 and about 90% of Cu²⁺ was released from the nanostructure, although more Cu²⁺ was released at pH 5 (100%) within the first 6 hours; this is as expected and is due to the pH sensitive nature of chitosan. The system quickly reached equilibrium, with approximately 92% release at pH 7 and 100% release at pH 5. The cumulative release of Cu²⁺ at pH 5 was approximately 14% higher than pH 7, indicating measurable but modest pH responsiveness. This may be due to the hydrophilic properties of Type I nanostructure, which contains a more hydrophilic shell. This hydrophilic surface readily facilitated wetting of the nanostructure, and most of the Cu²⁺ in that fraction can dissolve freely into the water.

Given that the Type I nanostructures showed a fast release within 6 hours, additional time points were studied over 24 hours for Type II nanostructures release kinetics. As shown in FIG. 4B, the Type II nanostructures showed a significantly lower cumulative release of Cu²⁺ at pH 7 and about 51% of Cu²⁺ was released from the nanostructure within the first 3 hours and the system continued to release Cu²⁺ and reached 63% at 24 hours. As expected, more Cu²⁺ was released at pH 5 (97%) within the first 3 hours, and then the system quickly reach equilibrium. The Cu²⁺ release amount at pH 5 was approximately 37% greater than pH 7 at 24 hours, indicating a higher level of pH responsiveness. This is likely due to the hydrophobicity of the Type II nanostructures, which has a more hydrophobic shell. With a more hydrophobic surface, the wettability of nanostructure is significantly reduced, and only the nanostructure surface was in contact with water. Therefore, less Cu²⁺ was able to dissolve due to the lack of water contact. Such a hydrophobic surface can retain and preserve more agrichemicals when the nanostructures are under neutral conditions. As the pH dropped to 5, chitosan began to become more soluble and more Cu²⁺ was released from the nanostructure.

Agrichemical release kinetics under enzymatic conditions. Cumulative Cu release from core-shell nanostructures at pH 7 and 25° C. in the presence or absence of protease and α-amylase is displayed in FIGS. 4C & D. As shown in FIG. 4C, the Type I nanostructures exhibited an obvious burst of Cu²⁺ release (90%) in both the enzyme solution and control (water) within the first 6 hours, largely due to the hydrophilic features of the particle. For the nanostructures in the absence of the enzyme, the system quickly reached equilibrium immediately after 6 hours, with approximately 90% release. However, for the nanostructures in solution with the enzyme, the cumulative Cu²⁺ release percent increased to 100% at day 3, which was 18% higher than the samples without enzyme, indicating a time dependence for biopolymer degradation.

As shown in FIG. 4B, the Type II nanostructures showed significantly lower cumulative Cu²⁺ release percent in the presence and absence of enzyme (40% and 51%, respectively) within the first 3 hours, compared to Type I nanostructures. The system continued to release Cu²⁺ and reached approximately 55% release in the presence of enzyme and 63% release in the absence of enzyme at day 1. It is worth noting that for Type II nanostructures, the enzymes had a minimal effect on the Cu²⁺ release profile, indicating the low enzyme responsiveness. This is likely due to the hydrophobic nature of the Type II nanostructures, which contains a more hydrophobic shell. Such surface hydrophobicity was not conducive for enzyme adhesion, which inhibited biopolymer degradation. However, for the more hydrophilic Type I nanostructures, a more significant increase in Cu²⁺ release in the presence of the enzymes was evident.

It is worth noting that different plant species may require different amounts of nutrients during seedling development and plant growth and that those requirements may change over the life cycle of the crop. Therefore, it is important to develop a versatile biopolymer-based nanoplatform with tunable responsive agrichemical release kinetics that can then be adapted for different plant species. Moreover, the developed core-shell nanostructures demonstrated versatile stimuli responsiveness. Specifically, the Type II nanostructure is more pH sensitive and could be suitable for plants under healthy conditions where the low pH of the rhizosphere induces agrichemical release. Conversely, the Type I nanostructure is more enzyme sensitive and could be used in pathogen infested conditions, when fungal release of extracellular enzymes induces agrichemical release.

### Greenhouse Studies

A greenhouse experiment was conducted to assess the ability of the Type II responsive core/shell nanostructures (containing 25 mg NPK and 0.8 mg Cu) to deliver critical macronutrients and micronutrients to soybean and wheat model plants grown under soil conditions (FIG. 1C). It is worth mentioning that the Type II nanostructures were selected for the greenhouse study due to its high pH sensitivity under healthy soil conditions.

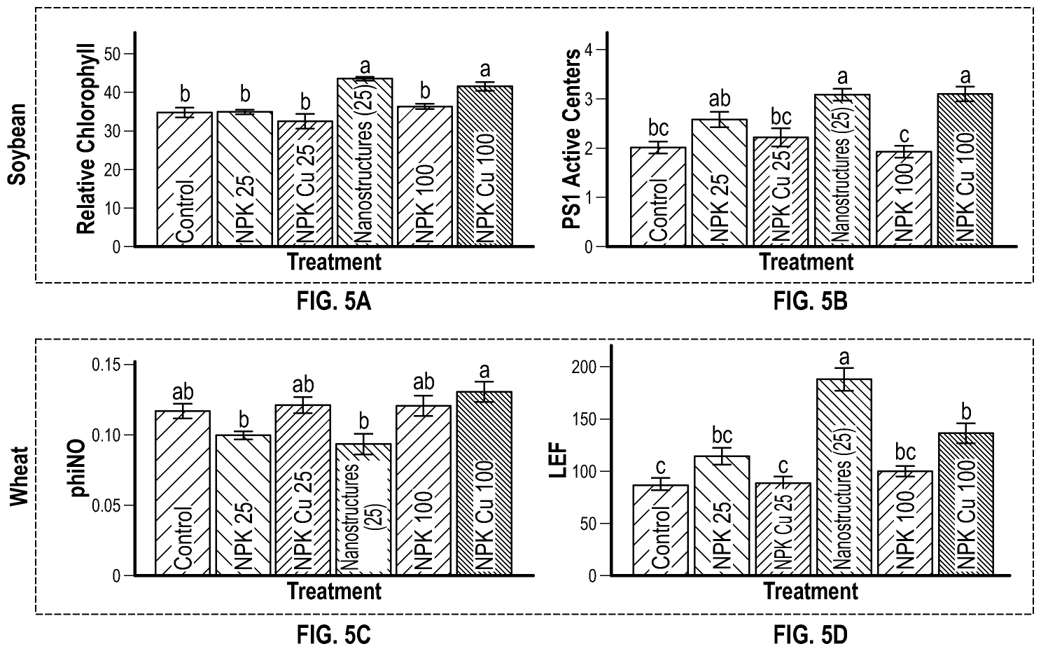

Plant photosynthesis. The effects of responsive core-shell nanostructures (loaded with model NPK and Cu) on photosynthesis were studied. FIG. 5A shows the relative chlorophyll content, which is an indirect measure of photosynthesis and productivity, of 4-week-old soybean seedlings; the nanostructures with a 25 mg NPK and Cu load yielded plants with 34.3% greater relative chlorophyll content compared to the ionic control with equivalent NPK and Cu content. The relative chlorophyll content in the nanostructure treatment group was equivalent to the conventional NPK and Cu at 100 mg, which has 4 times greater agrichemical content than the responsive nanostructures. It is worth noting that for 8-week-old wheat seedlings, the nanostructure treated plant group did not show significant differences for relative chlorophyll content, comparing to all other treatments.

Similar results were evident in the activity of PS1 centers in photosystem I (FIG. 5B), which is involved in the reception and passing of electrons. The nanostructure exposed soybean seedlings yielded 54.6% and 41.2% more than the control and plants treated with conventional 25 mg NPK and Cu, respectively (p≤0.05). More importantly, the PS1 centers in photosystem I in the nanostructure treatment group was equivalent to the conventional NPK and Cu exposed control group which was treated with four times more of the model agrichemicals (at 100 mg vs. 25 mg for the nanostructure treated group). For wheat seedling, the nanostructure treated plant group did not show significant differences for photosystem I, comparing to all other treatments

Furthermore, FIG. 5C shows the PhiNO level of 8-week-old wheat seedlings. PhiNO measures the amount of incoming light that is neither used for photosynthesis nor is dissipated, effectively causing potential damage to the leaf. This is highly important especially in areas that due to climate change are highly exposed to prolonged sunshine conditions. The plants exposed to nanostructures with 25 mg NPK and Cu showed similar value with those treated with 25 mg NPK and Cu, but significantly lower value by 28.5% than those treated with 100 mg NPK and Cu, suggesting a potential protection effect of the nanostructures in wheat leaves. For soybean seedling, the nanostructure treated group did not show significant differences for the PhiNO.

In addition, FIG. 5D shows the linear electron flow (LEF) of 8-week-old wheat seedlings. LEF indicates the amount of energy that is being moved through the chloroplasts following exposure to light. Notably, the nanostructure treated group (with 25 mg NPK and Cu) exhibited significantly greater values (187.7) than the control (87.2) and all other treatments (88.8-136.4), demonstrating enhanced electron flow and carbon fixation (p<0.05). For soybean seeding, the nanostructure treated group did not show significant differences for the LEF.

In summary, the results demonstrate that the responsive core shell nanostructure is a versatile and promising platform that can enhance photosynthesis in a fashion that is responsive to the demands of different plant species. Specifically, comparing to all other treatments, the nanostructure plant group with 25 mg NPK and Cu show significant differences for relative chlorophyll content and photosystem I in 4-week-old soybean seedlings, as well as LEF in 8-week-old wheat seedlings, indicating that the nanostructure effects on photosynthesis are plant specific. Photosynthesis converts solar energy, water, and carbon dioxide into ATP and glucose, and this enhancement could be attributed to the higher efficiency of agrichemicals delivery and utilization. More specifically, the responsive core shell nanostructure may release NPK and Cu at the right time and right dose in the soil as compared to conventional fertilizer application scenarios. More mechanistic plant specific studies will be performed in the future to optimize the growth of plants while tuning the agrichemical delivery strategy which is highly tunable as our results demonstrated in this study.

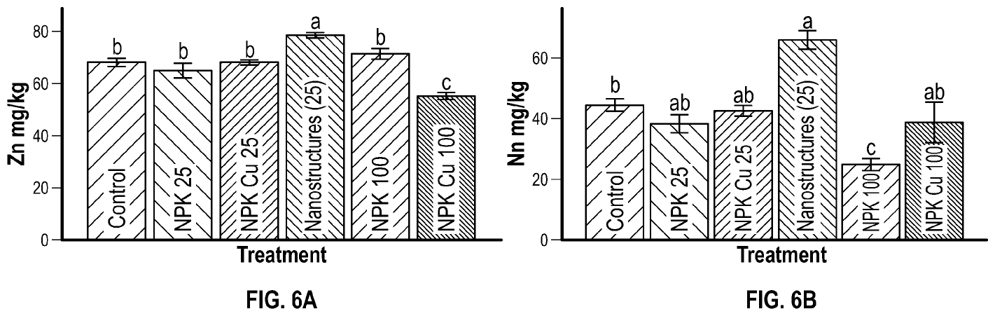

Element content. FIG. 6 shows that the zinc (Zn) (FIG. 6A) and sodium (Na) content (FIG. 6B) in the leaves of 4-week-old soybean seedlings were significantly increased in soybean shoots from the nanostructure treatment. Specifically, significantly greater Zn accumulation (78.6 mg/kg) was also induced by nanostructure application relative to the conventional 25 mg NPK with Cu (68 mg/kg) and 100 mg NPK with Cu (55.1 mg/kg). Zn is involved in the production of auxin, an essential growth hormone. An increased Zn level not only improves plant growth, but also enhances the nutritional quality of soybean plants. Additionally, the Na content was 48.1% and 55.7% higher than the controls and conventional 25 mg NPK with Cu, respectively (p≤0.05). Importantly, these findings suggest that NPK and Cu in this nanoscale form can potentially be used to modulate the accumulation of other important micronutrients through a potential biofortification strategy. However, additional elements such as Cu, Ca, Si, and Fe were not affected by the nanostructures.

Fresh biomass. The fresh biomass of soybean shoots was significantly increased by nanostructure treatment by ˜37% over the controls. This increase in biomass was not evident in the conventional NPK with/without Cu (25 mg) and NPK without Cu (100 mg) treatments. Similarly, only nanostructures and NPK with Cu (100 mg) significantly improved shoot growth of wheat relative to the control; this increase was not found in any other treatments. Specifically, the nanostructures resulted in higher shoot weight than the treatment of NPK with Cu (100 mg) and controls by 79.8% and 44.0%, respectively. The grain yield was unaffected by any of the treatments (p≤0.05). Importantly, the increase in wheat shoot fresh biomass was not evident in the other treatments (e.g., both 25 mg and 100 mg conventional NPK without Cu). It is clear that treatments with Cu (both nanostructure and conventional 100 mg NPK) facilitated shoot fresh biomass growth for both soybean and wheat. Cu is as an important micronutrient and can boost the plant immune system and subsequentially enhance plant growth. The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### EXEMPLARY EMBODIMENTS

The following exemplary embodiments are provided, the numbering of which is not to be construed as designating levels of importance:

Aspect 1 provides a nanostructured agrichemical delivery vehicle, the vehicle having a core-shell structure:
the core comprising a first polymeric material; and
the shell at least partially encasing the core, the shell comprising a second polymeric material,

wherein:
the core, the shell, or both comprise an agrichemical component distributed about the first polymeric material, the second polymeric material, or both; and
the release of the agrichemical component from the core, the shell or both is triggered by exposure to at least one of a predetermined enzyme, a predetermined pH, a predetermined biotic secretion, a predetermined temperature, a predetermined moisture content, a predetermined light source.

Aspect 2 provides the nanostructured agrichemical delivery vehicle of Aspect 1, wherein an average diameter of the nanostructured agrichemical delivery vehicle is in a range of from about 150 nm to about 300 nm.

Aspect 3 provides the nanostructured agrichemical delivery vehicle of any one of Aspects 1 or 2, wherein an average diameter of the nanostructured agrichemical delivery vehicle is in a range of from about 160 nm to about 170 nm.

Aspect 4 provides the nanostructured agrichemical delivery vehicle of any one of Aspects 1-3, wherein a thickness of the shell is in a range of from about 10 nm to about 50 nm.

Aspect 5 provides the nanostructured agrichemical delivery vehicle of any one of Aspects 1-4, wherein a thickness of the shell is in a range of from about 10 nm to about 40 nm.

Aspect 6 provides the nanostructured agrichemical delivery vehicle of any one of Aspects 1-5, wherein the first polymeric material, the second polymeric material comprise a polysaccharide-based biopolymer

Aspect 7 provides the nanostructured agrichemical delivery vehicle of any one of Aspects 1-6, wherein the first polymeric material comprises cellulose acetate, chitosan, zein, corn starch, polycaprolactone, or a mixture thereof.

Aspect 8 provides the nanostructured agrichemical delivery vehicle of any one of Aspects 1-7, wherein the first polymeric material comprises cellulose acetate, chitosan, zein, corn starch, and polycaprolactone.

Aspect 9 provides the nanostructured agrichemical delivery vehicle of any one of Aspects 7 or 8, wherein:
the cellulose acetate ranges from about 30 wt % to about 50 wt % of the first polymeric material;
the chitosan ranges from about 20 wt % to about 40 wt % of the first polymeric material;
the zein ranges from about 5 wt to about 20 wt % of the first polymeric material;
the corn starch ranges from about 5 wt to about 20 wt % of the first polymeric material; and
the polycaprolactone ranges from about 5 wt to about 20 wt % of the first polymeric material.

Aspect 10 provides the nanostructured agrichemical delivery vehicle of any one of Aspects 7-9, wherein:
the cellulose acetate ranges from about 35 wt % to about 45 wt % of the first polymeric material;
the chitosan ranges from about 25 wt % to about 35 wt % of the first polymeric material;
the zein ranges from about 10 wt to about 15 wt % of the first polymeric material;
the corn starch ranges from about 10 wt to about 15 wt % of the first polymeric material; and
the polycaprolactone ranges from about 10 wt to about 15 wt % of the first polymeric material.

Aspect 11 provides the nanostructured agrichemical delivery vehicle of any one of Aspects 1-10, wherein the second polymeric material comprises cellulose acetate, chitosan, polycaprolactone, or a mixture thereof.

Aspect 12 provides the nanostructured agrichemical delivery vehicle of any one of Aspects 1-11, wherein the second polymeric material comprises cellulose acetate, chitosan, and polycaprolactone.

Aspect 13 provides the nanostructured agrichemical delivery vehicle of any one of Aspects 11 or 12, wherein:
the cellulose acetate ranges from about 20 wt % to about 30 wt % of the second polymeric material;
the chitosan ranges from about 20 wt % to about 30 wt % of the second polymeric material; and
the polycaprolactone ranges from about 40 wt % to about 60 wt % of the second polymeric material.

Aspect 14 provides the nanostructured agrichemical delivery vehicle of any one of Aspects 11-13, wherein:
the cellulose acetate ranges from about 23 wt % to about 28 wt % of the second polymeric material;
the chitosan ranges from about 23 wt % to about 28 wt % of the second polymeric material; and
the polycaprolactone ranges from about 44 wt % to about 56 wt % of the second polymeric material.

Aspect 15 provides the nanostructured agrichemical delivery vehicle of any one of Aspects 1-14, wherein the shell ranges from about 45 wt % to about 62 wt % of the nanostructured agrichemical delivery vehicle.

Aspect 16 provides the nanostructured agrichemical delivery vehicle of any one of Aspects 1-15, wherein the shell ranges from about 47 wt % to about 60% of the nanostructured agrichemical delivery vehicle.

Aspect 17 provides the nanostructured agrichemical delivery vehicle of any one of Aspects 1-16, wherein the core ranges from about 38% to about 55 wt % of the nanostructured agrichemical delivery vehicle.

Aspect 18 provides the nanostructured agrichemical delivery vehicle of any one of Aspects 1-17, wherein the core ranges from about 40 wt % to about 53 wt % of the nanostructured agrichemical delivery vehicle.

Aspect 19 provides the nanostructured agrichemical delivery vehicle of any one of Aspects 1-18, wherein the agrichemical component comprises a micronutrient, a macronutrient, a pesticide, a fungicide, or a mixture thereof.

Aspect 20 provides the nanostructured agrichemical delivery vehicle of Aspect 19, wherein the micronutrient comprises copper, boron, zinc, manganese, iron, molybdenum, chlorine, or a mixture thereof.

Aspect 21 provides the nanostructured agrichemical delivery vehicle of Aspect 20, wherein the copper is CuSO₄.

Aspect 22 provides the nanostructured agrichemical delivery vehicle of any one of Aspects 19-21, wherein the macronutrient comprises nitrogen, phosphorus, potassium, or a mixture thereof.

Aspect 23 provides the nanostructured agrichemical delivery vehicle of any one of Aspects 1-22, wherein the agrichemical component is evenly distributed about the shell and the core.

Aspect 24 provides the nanostructured agrichemical delivery vehicle of any one of Aspects 1-23, wherein a major portion of a total amount of agrichemical component is in the core.

Aspect 25 provides the nanostructured agrichemical delivery vehicle of any one of Aspects 1-24, wherein a major portion of a total amount of agrichemical component is in the shell.

Aspect 26 provides the nanostructured agrichemical delivery vehicle of any one of Aspects 1-25, wherein the shell is free of the agrichemical component.

Aspect 27 provides the nanostructured agrichemical delivery vehicle of any one of Aspect 1-26, wherein a specific surface area of the nanostructured agrichemical delivery vehicle is in a range of from about 10 m²/g to about 30 m²/g.

Aspect 28 provides the nanostructured agrichemical delivery vehicle of any one of Aspect 1-27, wherein a specific surface area of the nanostructured agrichemical delivery vehicle is in a range of from about 13 m²/g to about 20 m²/g.

Aspect 29 provides the nanostructured agrichemical delivery vehicle of any one of Aspects 1-28, wherein the first polymeric material, the second polymeric material, or both are biodegradable.

Aspect 30 provides a method of making the nanostructured agrichemical delivery vehicle of any one of Aspects 1-29, the method comprising:
disposing a liquid core precursor composition in a first chamber of a coaxial dispenser, the liquid core precursor composition comprising the first polymeric material and optionally the agrichemical component;
disposing a liquid shell precursor in a second chamber of a coaxial dispenser, the liquid shell precursor composition comprising the second polymeric material and optionally the agrichemical component;
applying a voltage to the coaxial dispenser;
applying a voltage to a substrate in flow communication with the coaxial dispenser;
flowing the liquid core precursor composition from the first chamber to the substrate; and
flowing the shell precursor composition from the second chamber to the substrate.

Aspect 31 provides the method of Aspect 30, wherein the coaxial dispenser comprises an electrically conductive material.

Aspect 32 provides the method of Aspect 31, wherein the electrically conductive material is stainless steel.

Aspect 33 provides the method of Aspect 30-32, wherein the coaxial dispenser comprises a multi-needle.

Aspect 34 provides the method of any one of Aspects 30-33, wherein the voltage applied to the coaxial dispenser is a positive direct current voltage in a range of from about 15 kV to about 40 kV.

Aspect 35 provides the method of any one of Aspects 30-34, wherein the voltage applied to the coaxial dispenser is a positive direct current voltage in a range of from about 20 kV to about 35 kV.

Aspect 36 provides the method of any one of Aspects 30-35, wherein the voltage applied to the substrate is a negative direct current voltage in a range of from about 1 kV to about 15 kV.

Aspect 37 provides the method of any one of Aspects 30-36, wherein the voltage applied to the substrate is a negative direct current voltage in a range of from about 2 kV to about 10 kV.

Aspect 38 provides the method of any one of Aspects 30-37, wherein a flow rate of the core precursor and the shell precursor are substantially equivalent.

Aspect 39 provides the method of any one of Aspects 30-38, wherein a flow rate of the core precursor and the shell precursor are different.

Aspect 40 provides the method of any one of Aspects 30-39, wherein a flow rate of the core precursor and the shell precursor independently range from about 0.01 ml/h to about 0.6 ml/h.

Aspect 41 provides the method of any one of Aspects 30-40, wherein a flow rate of the core precursor and the shell precursor independently range from about 0.05 ml/h to about 0.4 ml/h.

Aspect 42 provides a method of using the nanostructured agrichemical delivery vehicle of any one of Aspects 1-41, the method comprising:
locating the nanostructured agrichemical delivery vehicle proximate to a plant.

Aspect 43 provides the method of Aspect 42, wherein the plant has not been germinated at a time of locating the nanostructured agrichemical delivery vehicle proximate thereto.

Aspect 44 provides the method of any one of Aspects 42 or 43, further comprising triggering release of the agrichemical.

Aspect 45 provides the method of Aspect 44, wherein triggering release of the agrichemical comprises, exposing the nanostructured agrichemical delivery vehicle to a predetermined enzyme, a predetermined pH, exposing the nanostructured agrichemical delivery vehicle to a predetermined biotic secretion, a predetermined temperature, a predetermined moisture content, a predetermined light source, or a combination thereof.

Aspect 46 provides the method of Aspect 45, wherein the biotic secretion comprises an exudate secreted from a plant pathogen, and insect, a weed species, or a combination thereof.

Aspect 47 provides the method of any one of Aspects 44-46, wherein the release of the agrichemical is a sustained release, an extended release, a staggered release, or a delayed release.

Aspect 48 provides a plant fertilized with the nanostructured agrichemical delivery vehicle of any one of Aspects 1-17.

1. A nanostructured agrichemical delivery vehicle, the vehicle having a core-shell structure:
the core comprising a first polymeric material; and
the shell at least partially encasing the core, the shell comprising a second polymeric material,
wherein:
the core, the shell, or both comprise an agrichemical component distributed about the first polymeric material, the second polymeric material, or both; and
a release of the agrichemical component from the core, the shell or both is triggered by exposure to at least one of a predetermined enzyme, a predetermined pH, a predetermined biotic secretion, a predetermined temperature, a predetermined moisture content, a predetermined light source.

2. The nanostructured agrichemical delivery vehicle of claim 1, wherein an average diameter of the nanostructured agrichemical delivery vehicle is in a range of from about 150 nm to about 300 nm.

3. The nanostructured agrichemical delivery vehicle of claim 1, wherein a thickness of the shell is in a range of from about 10 nm to about 50 nm.

4. The nanostructured agrichemical delivery vehicle of claim 1, wherein the first polymeric material comprises cellulose acetate, chitosan, zein, corn starch, polycaprolactone, or a mixture thereof.

5. The nanostructured agrichemical delivery vehicle of claim 1, wherein the first polymeric material comprises cellulose acetate, chitosan, zein, corn starch, and polycaprolactone.

6. The nanostructured agrichemical delivery vehicle of claim 5, wherein:
the cellulose acetate ranges from about 30 wt % to about 50 wt % of the first polymeric material;
the chitosan ranges from about 20 wt % to about 40 wt % of the first polymeric material;
the zein ranges from about 5 wt to about 20 wt % of the first polymeric material;
the corn starch ranges from about 5 wt to about 20 wt % of the first polymeric material; and
the polycaprolactone ranges from about 5 wt to about 20 wt % of the first polymeric material.

7. The nanostructured agrichemical delivery vehicle of claim 1, wherein the second polymeric material comprises cellulose acetate, chitosan, and polycaprolactone.

8. The nanostructured agrichemical delivery vehicle of claim 6, wherein:
the cellulose acetate ranges from about 20 wt % to about 30 wt % of the second polymeric material;
the chitosan ranges from about 20 wt % to about 30 wt % of the second polymeric material; and
the polycaprolactone ranges from about 40 wt % to about 60 wt % of the second polymeric material.

9. The nanostructured agrichemical delivery vehicle of claim 1, wherein the shell ranges from about 45 wt % to about 62 wt % of the nanostructured agrichemical delivery vehicle.

10. The nanostructured agrichemical delivery vehicle of claim 1, wherein the core ranges from about 38% to about 55 wt % of the nanostructured agrichemical delivery vehicle.

11. The nanostructured agrichemical delivery vehicle of claim 1, wherein the agrichemical component comprises a micronutrient, a macronutrient, a pesticide, a fungicide, or a mixture thereof.

12. The nanostructured agrichemical delivery vehicle of claim 1, wherein a major portion of a total amount of agrichemical component is in the core.

13. (canceled)

14. The nanostructured agrichemical delivery vehicle of claim 1, wherein a specific surface area of the nanostructured agrichemical delivery vehicle is in a range of from about 10 m²/g to about 30 m²/g.

15. (canceled)

16. A method of making the nanostructured agrichemical delivery vehicle of claim 1, the method comprising:
disposing a liquid core precursor composition in a first chamber of a coaxial dispenser, the liquid core precursor composition comprising the first polymeric material and optionally the agrichemical component;
disposing a liquid shell precursor in a second chamber of a coaxial dispenser, the liquid shell precursor composition comprising the second polymeric material and optionally the agrichemical component;
applying a voltage to the coaxial dispenser;
applying a voltage to a substrate in flow communication with the coaxial dispenser;
flowing the liquid core precursor composition from the first chamber to the substrate; and
flowing the shell precursor composition from the second chamber to the substrate.

17. The method of claim 16, wherein the coaxial dispenser comprises an electrically conductive material.

18. The method of claim 16, wherein the voltage applied to the coaxial dispenser is a positive direct current voltage in a range of from about 15 kV to about 40 kV.

19. (canceled)

20. (canceled)

21. A method of using the nanostructured agrichemical delivery vehicle of claim 1, the method comprising:
locating the nanostructured agrichemical delivery vehicle proximate to a plant.

22. The method of claim 21, wherein the plant has not been germinated at a time of locating the nanostructured agrichemical delivery vehicle proximate thereto.

23. The method of claim 21, further comprising triggering release of the agrichemical.

24. The method of claim 23, wherein triggering release of the agrichemical comprises, exposing the nanostructured agrichemical delivery vehicle to a predetermined enzyme, a predetermined pH, exposing the nanostructured agrichemical delivery vehicle to a predetermined biotic secretion, a predetermined temperature, a predetermined moisture content, a predetermined light source, or a combination thereof.
